(19) United States
(12) Patent Application Publication
(10) Pub. No.: US 2014/0266106 A1
(43) Pub. Date: Sep. 18, 2014

(54) LDO AND LOAD SWITCH SUPPORTING A WIDE RANGE OF LOAD CAPACITANCE

(71) Applicant: Vidatronic, Inc., College Station, TX (US)

(72) Inventors: Mohamed Ahmed Mohamed El-Nozahi, Heliopolis (EG); Mohamed Mostafa Saber Aboudina, College Station, TX (US); Sameh Assem Ibrahim, Cairo (EG); Faisal Abdellatif Elseddeek Ali Hussien, College Station, TX (US); Moises Emanuel Robinson, Austin, TX (US)

(21) Appl. No.: 13/916,252

(22) Filed: Jun. 12, 2013

Related U.S. Application Data
(63) Continuation-in-part of application No. 13/830,478, filed on Mar. 14, 2013.

(51) Int. Cl. G05F 1/575

(52) U.S. Cl. CPC G05F 1/575
USPC 323/280

(57) ABSTRACT

A novel architecture and method to maintain stability of a low drop-out (LDO)/load switch linear voltage regulator (LVR). The architecture and method also support optionally determining, during a power-up phase and by a capacitance sensing circuit, an estimated output capacitance value at an output node of the LDO/load switch LVR, and adjusting, based on the estimated output capacitance value, an adaptive RC network in the LDO/load switch LVR, wherein the adaptive RC network produces an adaptive zero in a feedback network transfer function of the LDO/load switch LVR, wherein the adaptive zero reduces an effect of a non-dominant pole in the open loop transfer function of the LDO/load switch LVR, and wherein a frequency of the adaptive zero is inversely proportional to the estimated output capacitance value.

### CROSS REFERENCE TO RELATED APPLICATIONS

This application is a continuation-in-part application of U.S. Non-provisional patent application Ser. No. 13/830,478 filed Mar. 14, 2013, and entitled “An LDO and Load switch supporting a WIDE Range of LOAD CAPACITANCE.” Accordingly, this application claims benefit of U.S. patent application Ser. No. 13/830,478 under 35 U.S.C. §120. U.S. patent application Ser. No. 13/830,478 is hereby incorporated by reference in its entirety.

### BACKGROUND

FIG. 1 shows a schematic block diagram of an LDO (low-dropout) linear voltage regulator (100) with high power supply rejection (PSR). The LDO linear voltage regulator is commonly referred to as simply “LDO.” As shown in FIG. 1, the feedback network (101), including a resistor divider and an error amplifier (102), regulates the DC output voltage Vₒᵤₜ to a desired level given by Vₒᵤₜ=V_{ref}*(1+R₁/R₂). The error amplifier (102) may be a single stage or a multi-stage amplifier. The resistor R₁ may be a short circuit, and the resistor R₂ may be an open circuit in some architectures. The pass transistor Mₚₐₛₛ may be either a field effect transistor (FET) or a bipolar transistor, and may be of either n-type or p-type. Multi-stage and high-gain amplifiers are typically used as the implementation of the error amplifier (102) in the feedback network (101). Cₑₓₜ (104) represents a physical off-chip external capacitor, and C_{L} (105) represents the load capacitance (without including Cₑₓₜ). The supply rejection block (103) is used to enhance the power supply rejection of the LDO (100). LDO architectures are generally categorized into two main categories: LDOs that require an external capacitor and LDOs that do not require an external capacitor.

Architectures that require an external capacitor to guarantee the stability of the LDO usually have superior performance over the other type. These performance parameters include both superior power supply rejection (PSR) and load transient regulation. Power supply rejection is the ability of the LDO to reject any noise coming from the supply through the Vᵢₙ terminal in FIG. 1. Throughout this disclosure, the terms, “power supply,” “supply,” “Vᵢₙ,” and “Vᵢₙ terminal” may be used interchangeably to refer to the power source input to a voltage regulator. Further, load transient regulation is the change in the output voltage Vₒᵤₜ when there is an instantaneous change in the load current, I_{L}. In prior art, LDOs that use an external capacitor achieve PSR of around 56 dB at 10 MHz, and load transient regulation of less than 10 mV when the load current changes from 1 to 100 mA in 1 μsec (with a load capacitance larger than 1 μF). The external capacitor is usually any capacitor that cannot be implemented on the same chip where the LDO is implemented.

On the other hand, LDOs that do not require an external capacitor are referred to as capacitor-less LDOs. Generally, the capacitor-less LDOs use on-chip capacitors. The main advantage of the capacitor-less implementation is that it does not require an external capacitor. This helps to reduce the cost of any device that uses this LDO. Capacitor-less LDOs are used to supply power to multiple circuits inside Systems-On-a-Chip (SOCs) and microprocessors, including embedded memories, PLLs, DLLs and high-speed interfaces. The main drawback of this architecture is that both PSR and load transient regulation are much worse than for LDOs using external capacitors. Prior art designs reported PSR worse than 50 dB at 1 MHz, and load transient regulation worse than 1V when the load current changes from 1 to 200 mA in 1 μsec. Increasing the load current makes these two parameters even worse. Prior art designs show that increasing the maximum current to 500 mA cause the PSR to be worse than 30 dB at 1 MHz. These two performance parameters show that the capacitor-less LDO cannot be used in many applications that require superior performance of PSR and load transient regulation.

FIG. 2 shows a schematic block diagram of a capacitor-less LDO (200) with high PSR (based on the supply rejection block (203)). As noted above, capacitor-less LDO (200) has degraded performance comparing to the LDO (100) shown in FIG. 1. The reason for the degraded performance is that the capacitor-less LDO (200) requires that the dominant pole of the open loop transfer function be placed in the feedback network (201), e.g., via the second stage amplifier (204) with the miller capacitor Cₘ shown in FIG. 2. Generally, the prior art implementations of capacitor-less LDOS place this dominant pole in the feedback loop. Placing the dominant pole in the feedback loop at the output of the error amplifier (202) makes the LDO (200) slower, and thus it does not react fast enough to the load transient variations and the input line variations. This is why the best PSR and load transient regulation of capacitor-less LDOs, such as the capacitor-less LDO (200), are typically limited to about 40 dB at 1 MHz, and 1V for a step in the load current of 200 mA in 1 μsec, respectively. Another drawback of many existing capacitor-less LDOs is that they cannot support capacitor loads from 0 to 10 micro-Farad (μF). Prior art capacitor-less LDOs typically become unstable (e.g., the LDO output would oscillate) if the output capacitor exceeds 1 nano-Farad (nF). On the contrary, prior art LDOs that require external capacitor cannot be used when the load capacitance is lower than 0.1 μF (e.g., the LDO output would oscillate). Accordingly, there is a need for an LDO that can support a wide range of load capacitance values ranging from 0 to 10 μF.

The load switch regulator has substantially the same structure as the LDO voltage regulator. The main difference between the LDO and the load switch regulator is the reference voltage (V_{ref}). In the case of LDO voltage regulator, V_{ref} is supply independent and usually generated from a bandgap reference voltage circuit. In the case of the load switch regulator, V_{ref} is a scaled (and filtered) version of the DC value of the supply. Thus, the DC level of the output voltage Vₒᵤₜ changes proportionally with the DC level of the input voltage Vᵢₙ. Accordingly, the block diagrams shown in FIGS. 1 and 2 may also be used to represent a load switch regulator with external capacitor and a capacitor-less load switch regulator, respectively. Similar to the capacitor-less LDO voltage regulators, capacitor-less load switch regulators have a limited PSR and load transient regulation of about 50 dB at 1 MHz, and 1V for a step in the load current of 200 mA in 1 μsec, respectively. Throughout this disclosure, the terms “load switch regulator,” “load switch linear voltage regulator,” and “load switch” may be used interchangeably. Further, the term “LDO/load switch linear voltage regulator” refers to either an LDO or a load switch depending on specific configurations of the reference voltage used.

### SUMMARY

In general, in one aspect, the invention relates to a novel architecture and method to maintain stability of a low drop-out (LDO)/load switch linear voltage regulator (LVR). The architecture and method also support optionally determining, during a power-up phase and by a capacitance sensing circuit, an estimated output capacitance value at an output node of the LDO/load switch LVR, and adjusting, based on the estimated output capacitance value, an adaptive RC network in the LDO/load switch LVR, wherein the adaptive RC network produces an adaptive zero in a feedback network transfer function of the LDO/load switch LVR, wherein the adaptive zero reduces an effect of a non-dominant pole in the open loop transfer function of the LDO/load switch LVR, and wherein a frequency of the adaptive zero is inversely proportional to the estimated output capacitance value.

In general, in one aspect, the invention relates to a linear voltage regulator (LVR) circuit. The LVR circuit includes a (i) feedback network comprising a first input coupled to an output of the LVR circuit, a second input coupled to a reference voltage, an optional third input coupled to a an optional capacitive sensing circuit block, and an output driving a gate terminal of a pass transistor, (ii) the pass transistor comprising the gate terminal driven by the output of the feedback network, a first terminal coupled to an input of the LVR circuit, and a second terminal coupled to the output of the LVR circuit, and (iii) the optional capacitive sensing circuit block comprising an input coupled to the output of the LVR circuit, and an output coupled to the third input of the feedback network.

In general, in one aspect, the invention relates to a low drop-out (LDO)/load switch linear voltage regulator (LVR) circuit, the LDO/load switch LVR circuit includes a MOS power device configured to generate a Vₒᵤₜ output from a Vᵢₙ input, and a feedback control circuit coupled to the MOS power device and configured to adjust a gate control signal supplied to the MOS power device for regulating a voltage level of the Vout output, wherein the gate control signal is adjusted based on a difference between a reference voltage signal and a sample of the voltage level of the Vout output, wherein the feedback network is configured to place a dominant pole at the Vout output without using an external capacitor.

In general, in one aspect, the invention relates to a low drop-out (LDO)/load switch linear voltage regulator (LVR) circuit, the LDO/load switch LVR circuit includes (i) a MOS power device configured to generate a Vₒᵤₜ output from a Vᵢₙ input, (ii) a feedback control circuit coupled to the MOS power device and configured to adjust a gate control signal supplied to the MOS power device for regulating a voltage level of the Vₒᵤₜ output, wherein the gate control signal is adjusted based on a difference between a reference voltage signal and a sample of the voltage level of the Vₒᵤₜ output, and (iii) an optional capacitance sensing circuit configured to estimate an output load capacitance at the Vₒᵤₜ output, wherein the feedback control circuit is optionally adjusted based on the estimated output load capacitance.

Other aspects of the invention will be apparent from the following description and the appended claims.

### BRIEF DESCRIPTION OF DRAWINGS

The appended drawings illustrate several embodiments of the invention and are not to be considered limiting of its scope, for the invention may admit to other equally effective embodiments.

FIG. 1 shows a schematic block-level circuit diagram of an LDO/load switch linear voltage regulator, in which embodiments of the invention may be implemented.

FIG. 2 shows a schematic block-level circuit diagram of a typical prior art capacitor-less LDO/load switch linear voltage regulator.

FIG. 3 shows a schematic block-level circuit diagram of a capacitor-less LDO/load switch linear voltage regulator in accordance with embodiments of the invention.

FIG. 4 shows a schematic block-level circuit diagram, in the open loop configuration, of a capacitor-less LDO/load switch linear voltage regulator in accordance with embodiments of the invention.

FIG. 5 shows a schematic block-level circuit diagram of a capacitor-less LDO/load switch linear voltage regulator with an additional and optional load capacitive sensing circuitry in accordance with embodiments of the invention.

FIG. 6 shows the timing diagram to power on a capacitor-less LDO/load switch linear voltage regulator in accordance with embodiments of the invention.

FIG. 7 shows example simulation results for phase margin under different load conditions of a LDO linear voltage regulator/load switch voltage regulator in accordance with embodiments of the invention.

FIGS. 8A-8B show example simulation results for load transient regulation of a LDO linear voltage regulator/load switch voltage regulator in accordance with embodiments of the invention.

FIG. 9 shows example simulation results for power supply rejection of a LDO linear voltage regulator in accordance with embodiments of the invention.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

Embodiments of the invention relate to a capacitor-less LDO and/or load switch linear voltage regulator with an improved architecture that is capable of driving a load capacitance ranging from 0 to 10 micro-Farads (μF) while achieving improved power supply rejection and load transient regulation. In one or more embodiments of the invention, the improved LDO/load switch architecture achieves PSR better than 45 dB at 10 MHz for load currents larger than 500 mA, and load transient regulation better than 60 mV for a step in the load current from 0 mA to 200 mA in 1 μsec without an external capacitor. Power supply rejection and load transient regulation are even better if an external capacitor is used. The following features of the invention will be described using the capacitor-less LDO as example, those skilled in the art, with the benefit of this disclosure will appreciate that same or similar features are equally applicable to the load switch as well.

In one or more embodiments, the LDO linear voltage regulator with the improved feedback network is implemented on a microchip, such as a semiconductor integrated circuit. As noted above, capacitor-less LDO voltage regulators do not require an external capacitor. In particular, many prior art capacitor-less LDOs fail to function properly with any external capacitor. In one or more embodiments, the improved capacitor-less LDO may function properly with or without an external capacitor. Throughout this disclosure, the Willis “LDO,” “LDO linear voltage regulator,” “capacitor-less LDO,” “improved capacitor-less LDO,” and “LDO linear voltage regulator with the improved feedback network” may be used interchangeably depending on the context.

In one or more embodiments, the improved capacitor-less LDO linear voltage regulator has a dominant pole at the LDO output node (i.e., the Vₒᵤₜ terminal) instead of placing the dominant pole in the feedback network. As noted above, the dominant pole of an example prior art capacitor-less LDO solution is placed at the output of the error amplifier (e.g., the error amplifier (202) depicted in FIG. 2 above). Placing the dominant pole at the LDO output node increases the speed of the feedback network such that the LDO reacts to load current variations and supply noise variations with improved response time. This leads to better PSR and transient load regulation. In one or more embodiments, placing the dominant pole at the LDO output node allows the use of an additional off-chip capacitor to achieve better performance parameters. For example, this approach may allow the use of an optional off-chip load capacitance anywhere from 0 to 10 μF. Typically, forcing the LDO output node to be the dominant pole in capacitor-less LDO solutions requires a large output capacitor that cannot be integrated on the same chip. Embodiments of the invention use a particular circuit configuration shown in FIG. 3 to overcome this issue.

FIG. 3. shows a schematic block-level circuit diagram of an improved capacitor-less LDO (300) that includes a feedback network (301) (including an error amplifier (302) (e.g., a single or multi-stage amplifier), a capacitor Cₘ (306), a second voltage buffer (304), a first voltage buffer (305), and a resistive divider network formed by a resistor (308) and a resistor (309)), a pass transistor device Mₚₐₛₛ (307), a supply rejection block (303), and a load capacitor C_{L} (311). In addition, the current source I_{L} (310) represents the load current of the improved capacitor-less LDO (300). In particular, the improved capacitor-less LDO (300) is essentially the same as the LDO (100) where the feedback network (101) is implemented using an improved feedback network described below to eliminate the need of the external capacitor Cₑₓₜ (104) shown in FIG. 1. Although the pass transistor device (307) is shown in FIG. 4 as an NMOS transistor, other types of the devices, such as PMOS transistor, NPN or PNP bipolar junction transistors may also be used. In one or more embodiments, the error amplifier (302) may be a single-stage amplifier or a multi-stage amplifier, and one or more of the second voltage buffer (304) and the first voltage buffer (305) may provide a gain or attenuation. In one or more embodiments of the invention, one or more of the modules and elements shown in FIG. 3 may be omitted, repeated, and/or substituted. Accordingly, embodiments of the invention should not be considered limited to the specific arrangements of modules shown in FIG. 3.

In one or more embodiments, forcing the dominant pole at the output of the improved capacitor-less LDO (300) is achieved by amplifying the value of the capacitor Cₘ (306) with the gain of the error amplifier (302). Depending on the gain, the capacitor Cₘ (306) may have an equivalent capacitance (referred to as the effective output capacitance) at the output node Vₒᵤₜ that is much larger than the value of Cₘ (306). Specifically, the effective output capacitance is Cₘ*Aₑ, where Aₑ is the gain of the error amplifier (302). For example, a 100 pica-Farad (pF) capacitor (i.e., Cₘ (306)) across an amplifier (i.e., error amplifier (302)) with a gain of 10000 is equivalent to an effective load capacitance of μF at the output node (i.e., Vₒᵤₜ terminal of the capacitor-less LDO (300)). The 1 μF is comparable to the external capacitors used for the LDOs that require an external capacitor to operate. Thus, the improved capacitor-less LDO (300) has an effective output capacitance that is similar to the LDO architectures requiring an external capacitor. Accordingly, the need for an external capacitor is eliminated in the improved capacitor-less LDO (300) and the cost of the overall system is reduced. In one or more embodiments, the first voltage buffer (305) is used to isolate the output node of the error amplifier (302) such that it is not affected by the variations in the load current I_{L} (310) to achieve better load transient regulation. Also, the first voltage buffer (305) introduces a zero to cancel one of the non-dominant poles in the system. In one or more embodiments, the second voltage buffer (304) is used to drive the large parasitic capacitance introduced by the pass transistor device Mₚₐₛₛ (307). Although the second voltage buffer (304) and the first voltage buffer (305) are used to achieve better load transient regulation and PSR performances, in one or more embodiments, the second voltage buffer voltage buffer (304) and the first voltage buffer (305) are not required for placing the dominant pole at the output of the capacitor-less LDO (300). In one or more embodiments, the improved capacitor-less LDO (300) supports load capacitances ranging from 0 to 10 nF.

FIG. 4 shows a schematic block-level circuit diagram, in the open loop configuration, of an improved capacitor-less LDO linear voltage regulator (400). In one or more embodiments, the terminals V_{gpass} and V_{gpass,fb} of the LDO (400) are connected together to form the closed loop configuration similar to the LDO (100) shown in FIG. 1 or the improved capacitor-less LDO (300) shown in FIG. 3. Specifically, with the exception of being shown in the open loop configuration, the improved capacitor-less LDO (400) is essentially the same as the improved capacitor-less LDO (300) with output resistances/capacitances of various amplifier/buffer elements explicitly shown as circuit elements. In other words, as shown in FIG. 4, the error amplifier (402), the supply rejection block (403), the second voltage buffer (404), the first voltage buffer (405), the pass transistor device (407), the load current (410), and the load capacitor (411) are equivalent to the error amplifier (302), the supply rejection block (303), the second voltage buffer (304), the first voltage buffer (305), the pass transistor device (307), the load current (310), and the load capacitor (311), respectively, shown in FIG. 3 above. Further as shown in FIG. 4, the error amplifier (402), the first voltage buffer (405), and the second voltage buffer (404) are referred to as the transconductance amplifiers Gₘ₁, G_{m,B1}, and G_{m,B2}, respectively. Further, rₒ₁, r_{oB1}, and r_{o,B2} represent equivalent resistances at the output nodes of the transconductance amplifiers Gₘ₁, G_{m,B1}, and G_{m,B2}, respectively. Further still, cₒ₁, c_{o,B1}, and c_{o,B2} represent equivalent capacitances at the output nodes of the transconductance amplifiers Gₘ₁, G_{m,B1}, and G_{m,B2}, respectively.

Mathematical analysis shows that the open loop transfer function from V_{gpass,fb} to V_{gpass} is given by TF=(V_{gpass}/V_{gpass,fb})=A₀(1+s/ω_{cz})/(1+β₁s+β₂s²+β₃s³)=(1+s/ω_{cz})/[(1+s/ωₚ₁)(1+s/ωₚ₂)(1+s/ωₚ₃), where A₀ is the DC gain, ω_{cz} is a zero, s=jω, ω is the frequency in radians, and β₁, β₂, and β₃ are the coefficients responsible for the dominant and non-dominant poles, given by ωₚ₁, ωₚ₂, and ωₚ₃, in the transfer function. A₀, ω_{cz}, β₁, β₂, and β₃ are functions of the circuit element values in FIGS. 3 and 4. As is known to those skilled in the art, a pole or a zero of a transfer function (e.g., V_{gpass}/V_{gpass,fb}) refers to a frequency at which the transfer function becomes infinity or zero, respectively. The pole frequency is usually approximately given by the product of the total resistance to ground and the total capacitance to ground at any circuit node. In this context, the pole is said to be placed at the circuit node. The main limitation of this architecture is that the non-dominant pole, ωₚ₃, introduced by coefficient β₃ starts to move lower in frequency as the value of the load capacitance C_{L} (411) increases. Therefore, the stability of the improved capacitor-less LDO (400) for larger load capacitances is affected. This happens because the coefficient β₃ is proportional to the load capacitance C_{L} (411). As C_{L} (411) increases in value, β₃ increases resulting in the non-dominant pole moving lower in frequency, and thus limiting the maximum value of the load capacitance C_{L} (411). In one or more embodiments, the maximum value of the load capacitance C_{L} (411) is limited to 10 nF.

The aforementioned limitation of the circuit of FIG. 3 can be relieved using either of the following two approaches: (1) through circuit level optimization of the key blocks and parameters of FIG. 3, or (2) by adding an optional load capacitance sensing scheme illustrated in FIG. 5 to dynamically adjust the internal parameters of the LDO. These circuit elements could be either inside and/or outside the same chip including the capacitor-less LDO. The optional capacitive sensing approach can be applied to the existing LDO architectures, and is not limited to the circuit invention shown in FIG. 3. Using the two optimization approaches, the LDO of FIG. 3 is able to support capacitances from 0 to 10 μF.

FIG. 5 shows an improved capacitor-less LDO linear voltage regulator (500) with an additional and optional load capacitive sensing circuitry to support a wide range of load capacitances from 0 to 10 μF. In particular, the optional load capacitive sensing circuitry includes three circuit blocks, namely the chip controller block (514), the capacitance sensing block (513), and the variable zero block (512). The remaining elements of the improved capacitor-less LDO (500) are essentially the same as corresponding elements shown in FIG. 3 above. Specifically, as shown in FIG. 5, the error amplifier (502), the supply rejection block (503), the second voltage buffer (504), the first voltage buffer (505), the pass transistor device (507), the load current (510), and the load capacitor (511) are equivalent to the error amplifier (302), the supply rejection block (303), the second voltage buffer (304), the first voltage buffer (305), the pass transistor device (307), the load current (310), and the load capacitor (311), respectively, shown in FIG. 3 above. Further, the error amplifier (502), the second voltage buffer (504), and the first voltage buffer (505) can be turned off by a LVR on/off signal (514a). In one or more embodiments, the feedback network (501) is a combination of the feedback network (301) and the variable zero block (512). In one or more embodiments, the optional capacitance sensing block (513) is used to initially estimate the capacitance of the load capacitor (511) before the improved capacitor-less LDO (500) starts supplying the load current (310).

In one or more embodiments, the capacitance sensing block (513) includes a current source, a comparator, a counter, and a clock. Each clock cycle the counter increments its count by one. The current source initially starts to charge the off-chip load capacitor C_{L} (511). As a result, the output voltage Vₒᵤₜ starts to increase with time. At the same time, the counter is incrementing with time based on the clock. Once the output voltage Vₒᵤₜ reaches a pre-specified value, the counter stops counting at a final count. The final count is proportional to the load capacitance of C_{L} (511). In other words, a higher final count corresponds to a larger load capacitance value, and vice versa. Accordingly, the final count represents an estimate of the load capacitance of C_{L} (511). During the load capacitance estimation phase, the Mₚₐₛₛ (507) is switched off. Once the load capacitance value is estimated, a control signal (513a) is generated by the capacitance sensing block (513) to control the variable zero block (512). This control signal (513a) may be an analog signal or a digital signal (e.g., a digital word pattern). In response, the variable zero block (512) introduces a zero (referred to as an adaptive zero) in the transfer function (V_{gpass}/V^{gpas,fb}) to reduce or cancel the effect of the unwanted pole ωₚ₃ having a changing value affected by capacitance variations of the load capacitor (511). The modified transfer function (V_{gpass}/V_{gpas,fb}) can be approximated by TF≅(1+s/ω_{cz})(1+s/ω_{cz2})/[(1+s/ωₚ₁)(1+s/ωₚ₂)(1+s/ωₚ₃)], where ω_{cz2} is the zero introduced by the variable zero block (512). In one or more embodiments, the variable zero block (512) includes a resistance-capacitance network, wherein the control signal (513a) changes the value of the resistance and/or the capacitance of the resistance-capacitance network. The variable zero block (512) may be a 1^{st} order low pass filter (LPF) based on a single resistance and capacitance. The input terminal of variable zero block (512) is the input of the LPF and the output terminal of the variable zero block (512) is the output of the LPF. The frequency of the adaptive zero may be adjusted by changing either the value of the resistance or the capacitor in the LPF. In one or more embodiments, the frequency of the adaptive zero is inversely proportional to the estimated output capacitance value to reduce phase margin degradation due to at least one non-dominant pole (e.g., ωₚ₃) of the open loop transfer function of the LDO/load switch LVR. As a result, the LDO linear voltage regulator (500) remains stable over a number of capacitive load conditions ranging from no capacitive load to a 10 μF load.

FIG. 6 shows an example timing diagram (600) to illustrate the operation of the chip controller block (514), the capacitance sensing block (513), and the variable zero block (512) during power on phase of the capacitor-less LDO linear voltage regulator (500) shown FIG. 5. As shown in FIG. 6, the timing diagram (600) includes track A through track D corresponding to the supply voltage input, the cap sensing on/off signal (514b), the control signal (513a), and the LVR on/off signal (514a), respectively, shown in FIG. 5.

Specifically, track A shows Vᵢₙ (i.e., supply voltage input to the capacitor-less LDO linear voltage regulator (500)) ramping from zero volt to a stable DC level during the ramp-up time (601). Track B shows the cap sensing on/off signal (514b) generated by the chip control block (514) to define a cap_sensing_on window (602) starting from when Vᵢₙ reaches a reliable voltage level (603) at the input terminal “Supply” of the chip control block (514). During the cap_sensing_on window (602), the cap sensing on/off signal (514b) activates the capacitance sensing block (513) to perform load capacitance estimation. Track C shows the control signal (513a) generated by the capacitance sensing block (513) as the load capacitance estimation is completed. Specifically, the control signal (513a) controls the variable zero block (512) to adapt the aforementioned zero to the required frequency.

Track D shows the LVR on/off signal (514a) generated by the chip controller block (514) to keep the capacitor-less LDO linear voltage regulator (500) in an off state by turning off various active elements. As a result, the Mₚₐₛₛ transistor (507) is turned off during the cap_sensing_on window (602) allowing the output voltage Vₒᵤₜ to be controlled by the capacitance sensing block (513). Subsequent to the completion of the load capacitance estimation, the cap sensing on/off signal (514b) turns off the capacitance sensing block (513) and the LVR on/off signal (514a) turns on the capacitor-less LDO/load switch linear voltage regulator (LVR). Although a specific timing sequence is shown in FIG. 6, different timing approach may also be used and the invention is not limited to embodiments shown in FIG. 6.

FIG. 7 shows example simulation results for phase margin under different load conditions of the capacitor-less LDO linear voltage regulator (500) shown in FIG. 5. Specifically, FIG. 7 shows phase margin simulation results of two load conditions 100 μA and 200 mA in combination with three variable zero settings. Variable zero setting 1, 2, and 3 are for load capacitances ranging from 100 nF to 2 μF, 10 nF to 200 nF, and 0 nF to 20 nF, respectively. The variable zero setting 1 forces the zero of the variable zero block (512) to be placed at a lower frequency. As the load capacitance is decreased, the variable zero settings 2 and 3 increase the frequency of the zero generated by the variable zero block (512). Based on these simulation results, the optional capacitance sensing technique to adapt the internal zero in the improved capacitor-less LDO (500) achieves a phase margin better than 45 degree over a load capacitance range up to 10 μF. This enables the improved capacitor-less LDO (500) to supply load current up to a value larger than 500 mA.

FIGS. 8A-8B shows example simulation results for load transient regulation of the capacitor-less LDO linear voltage regulator (500) shown in FIG. 5. Specifically, FIGS. 8A and 8B show example simulation results for load capacitances of 100 pF and 1 μF, respectively. These simulation results demonstrate that load transient regulation better than 80 mV is achieved when the load current changes from 1 mA to 200 mA in 1 μsec. In all the simulated examples, load capacitances up to 10 μF are supported by the improved capacitor-less LDO (500). In contrast, prior art capacitor-less LDO architectures cannot support this wide range of load capacitances, and the reported load transient regulation is worse than 1 V for the same test conditions used in the simulated example (with no external capacitor or a very small external capacitor of around 100 pF). On the other hand, LDOs that require an external capacitor can achieve similar load transient regulation but cannot support load capacitances ranging from 0 to 10 μF.

In one or more embodiments, a supply rejection circuit (i.e., supply rejection blocks (303), (403), and (503) shown in FIGS. 3, 4, and 5 above) is used as an additional supply noise rejection circuit that injects a scaled version of the supply ripples at the gate of the pass transistor device (i.e., Mₚₐₛₛ) in FIGS. 3, 4, and 5 to cancel out the effects of input ripples in Vᵢₙ on the output voltage Vₒᵤₜ. Hence, a higher PSR is achieved for DC operation. The input ripples are any supply noise appearing at the input terminal (Vᵢₙ) of the LDO (100) of FIG. 1, LDO (300) of FIG. 3 or LDO (500) of FIG. 5. Those skilled in the art, with the benefit of this disclosure will appreciate that other circuit configurations may also be used to replicate supply noise for injecting to a particular circuit node in the LDO.

Simulations have shown that the LDOs (300) and (500), depicted in FIGS. 3 and 5 above, may achieve PSR of 50 and 35 dB at 1 MHz and 10 MHz, respectively without the supply rejection block. The PSR is enhanced by at least 15 dB across a wide frequency range when the supply rejection block is introduced. FIG. 9 shows the PSR simulation results at DC, 1 MHz and 10 MHz for the LDOs (300) and (500). As shown, a PSR better than 70 dB is achieved up to a frequency of 1 MHz, and better than 45 dB up to 10 MHz for a wide range of load conditions. This simulation is done for a load capacitance of 100 pF and load currents up to 200 mA. The simulation circuit parameters include an open loop gain higher than 70 dB, an amplifier offset better than 5 mV, and the value of Cₘ is 200 pF. In contrast, simulations show that prior art capacitor-less LDOs (e.g., shown in FIG. 2) typically achieve only 40 dB and 0 dB of PSR at 1 MHz and 10 MHz, respectively.

While the invention has been described for a low drop-out regulator, the same technique and circuit configuration are equally applicable for a load switch. The load switch can be seen as a device with two main terminals, one terminal is the input supply and the other terminal is the output voltage (e.g., the device may include other terminals such as a ground and an enable terminal). The output DC voltage changes proportionally with the input DC voltage. This load switch filters the high frequency supply noise without propagating it to the output. Similar to the capacitor-less LDO, there is also a capacitor-less load switch.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A low drop-out (LDO)/load switch linear voltage regulator (LVR) circuit, comprising:
a feedback network comprising:
a first input coupled to an output of the LVR circuit;
a second input coupled to a reference voltage; and
an output driving a gate terminal of a pass transistor; and
the pass transistor comprising:
the gate terminal driven by the output of the feedback network;
a first terminal coupled to an input of the LVR circuit; and
a second terminal coupled to the output of the LVR circuit,
wherein the feedback network further comprises a resistive divider, an error amplifier, a first buffer, a second buffer, and a capacitor.

2. The LVR circuit of claim 1,
wherein the feedback network is configured to regulate an output voltage level of the output of the LVR circuit based on a reference voltage, and
wherein the pass transistor comprises at least one selected from a group consisting of an n-type field effect transistor, a p-type field effect transistor, and a bipolar junction transistor.

3. The LVR circuit of claim 2, wherein the LVR circuit remains stable over a plurality of capacitive load conditions ranging from no capacitive load to a 10 μF load.

4. The LVR of claim 3, wherein a dominant pole of an open loop transfer function of the LVR is at the output of the LVR circuit over a pre-determined frequency range and a plurality of pre-determined load conditions.

5. The LVR circuit of claim 4,
wherein the first buffer comprises:
an input coupled to an output of the error amplifier and an input of the second buffer; and
an output coupled to a first terminal of the capacitor,
wherein the error amplifier comprises:
a first input for receiving the reference voltage; and
a second input coupled to an output of the resistive divider,
wherein the resistive divider comprises:
an input connected to the output of the LVR; and
an output connected to the second input of the error amplifier,
wherein the capacitor comprises:
a first terminal connected an output of the first buffer; and
a second terminal connected to the output of the LVR,
wherein the second buffer comprises an output driving the gate terminal of the pass transistor, and
wherein the resistive divider scales down the output voltage level of the LVR.

6. The LVR circuit of claim 5, wherein the first buffer is configured to:
isolate the output of the error amplifier from being affected by load current variations of the LVR circuit; and
add a zero to the open loop transfer function of the feedback network to reduce an effect of a non-dominant pole of the open loop transfer function.

7. The LVR circuit of claim 6, wherein the second buffer is configured to increase a gain of the feedback network and driving the pass transistor.

8. The LVR circuit of claim 1, further comprising:
a zero generation circuit configured to generate the zero,
wherein the input of the first buffer is coupled to the output of the error amplifier and the input of the second buffer via the zero generation circuit.

9. The LVR circuit of claim 8,
wherein the zero generation circuit comprises an RC network forming a low pass filter.

10. The LVR circuit of claim 9, wherein the RC network comprises at least one selected from a group consisting of a capacitor and a resistor.

11. The LVR circuit of claim 1, wherein the feedback network further comprises a third input coupled to an optional capacitive sensing block.

12. The LVR circuit of claim 11, wherein the optional capacitive sensing block comprises an input coupled to the output of the LVR circuit, and an output coupled to the third input of the feedback network.

13. The LVR of circuit of claim 12, wherein the capacitance sensing circuit block comprises:
a current source comprising:
a first terminal coupled to the output of the LVR circuit; and
a second terminal coupled to ground;
a comparator comprising:
a first input coupled to the output of the LVR circuit; and
a second input coupled to a constant voltage; and
a counter configured to generate a count proportional to a time period for the current source to charge the load capacitance for the output of the LVR circuit to reach the constant voltage.

14. The LVR of circuit of claim 12, further comprising a chip controller configured to:
activate the capacitive sensing circuit block during a power up phase of the LVR circuit; and
de-activate the capacitive sensing circuit block subsequent to the power up phase of the LVR circuit.

15. The LVR of circuit of claim 13, where the count represents the estimated load capacitance.

16. The LVR circuit of claim 1, further comprising:
a supply rejection circuit configured to inject input ripples into the LVR circuit to reduce an effect of the input ripples.

17. The LVR circuit of claim 1, wherein the LVR circuit is at least one selected from a group consisting of a capacitor-less low drop-out LVR and a capacitor-less load switch LVR.

18. A low drop-out (LDO)/load switch linear voltage regulator (LVR) circuit comprising:
a pass transistor configured to generate a Vₒᵤₜ output from a Vᵢₙ input; and
a feedback control circuit coupled to the pass transistor and configured to adjust a gate control signal supplied to the pass transistor for regulating a voltage level of the Vₒᵤₜ output, wherein the gate control signal is adjusted based on a difference between a reference voltage signal and a sample of the voltage level of the Vₒᵤₜ output,
wherein the feedback network is configured to place a dominant pole at the Vₒᵤₜ output without using an external capacitor.

19. A low drop-out (LDO)/load switch linear voltage regulator (LVR) circuit comprising:
a pass transistor configured to generate a Vₒᵤₜ output from a Vᵢₙ input;
a feedback control circuit coupled to the pass transistor and configured to adjust a gate control signal supplied to the pass transistor for regulating a voltage level of the Vₒᵤₜ output, wherein the gate control signal is adjusted based on a difference between a reference voltage signal and a sample of the voltage level of the Vₒᵤₜ output; and
a capacitance estimating circuit configured to estimate an output load capacitance at the Vₒᵤₜ output, wherein the feedback control circuit is adjusted based on the estimated output load capacitance.
